(19) United States
(12) Patent Application Publication
(10) Pub. No.: US 2011/0079344 A1
(43) Pub. Date: Apr. 7, 2011

(54) METHOD FOR MAKING A THIN FILM HAVING A METALLIC PATTERN LAYER

(75) Inventor: Victor Shi-Yueh Sheu, Taoyuan (TW)

(73) Assignees: Victor Shi-Yueh Sheu, Taoyuan (TW); Sheng-Li Hsu, Lujhou City (TW)

(21) Appl. No.: 12/573,112

(22) Filed: Oct. 3, 2009

(51) Int. Cl. B32B 38/10; B32B 37/14

(52) U.S. Cl. 156/151; 156/247

(57) ABSTRACT

A method for making a thin film having a metallic pattern layer includes covering a release layer on the surface of a thin film substrate to leave a blank area of a predetermined pattern in the release layer, covering a metal layer on the release layer and the blank area, covering the metal layer with an adhesive layer, adhering a substrate-based thin film to the adhesive layer, and removing the substrate-based thin film to remove the part of the metal layer outside said blank area and the release layer together with the adhesive layer and the substrate-based thin film from the thin film substrate so that a metallic pattern layer is left on the thin film substrate for RFID (radio frequency identification) system, antennas of wireless transmission system, flexible printed circuit boards or chip on film (chip on flex) applications.

### BACKGROUND OF THE INVENTION

(a) Field of the Invention

The present invention relates to a thin film fabrication method and more particularly to a method for making a thin film having a metallic pattern layer, which avoids chemical solvent and reagent washing and chemical etching.

(b) Description of the Prior Art

Metal transfer-printing film or metal thin film has been intensively used in RFID (radio frequency identification) systems, antennas of wireless transmission systems, flexible printed circuit boards or chips on film (chips on flex), A metal transfer-printing film or metal thin film for this purpose is applied to coat a specially patterned metal layer on the surface of a thin substrate by sputter deposition, vacuum deposition (vacuum evaporation coating) or electroplating technique. An RF (radio frequency) transceiver chip or another type of wireless transmission chip is electrically connected to the terminal of the metal transfer-printing film or metal thin film to induce RF signals or other wireless signals. The fabrication of a metal transfer-printing film or metal thin film includes coating a metal coating on the whole surface of a thin substrate, and washing the metal coating with an acidic solvent, alkaline solvent or other chemical solvents or reagents, to remove and etch the unnecessary part from the metal coating. This fabrication method produces a big amount of harmful heavy metal waste fluid or waste chemical solvent that must be properly treated before being discharged into a river. This heavy metal waste fluid or waste chemical solvent treatment procedure greatly increases the manufacturing cost of the metal transfer-printing film or metal thin film. If the harmful heavy metal waste fluid or waste chemical solvent is directly discharged into a river without any treatment, it will cause a severe environmental pollution.

Therefore, it is desirable to provide a method for making a thin film having a metallic pattern layer that eliminates the aforesaid problems.

### SUMMARY OF THE INVENTION

The present invention has been accomplished under the circumstances in view. A main object of the present invention is to provide a method for making a thin film having a metallic pattern layer, which enables a metallic pattern layer to be formed on a thin film substrate without any chemical washing step, thereby achieving cost-saving and environmental protection.

To achieve this and other objects of the present invention, a method for making a thin film having a metallic pattern layer comprises the steps of: (1) preparing a thin film substrate and covering a release layer on the surface of the thin film substrate by means of one of the techniques of spray-painting, coating and printing, to leave a blank area of a predetermined pattern, such as lines, letters, symbols and/or numerals and so on, in the release layer; (2) covering a metal layer on the whole surface of the release layer and the blank area; (3) covering the surface of the metal layer with an adhesive layer by means of one of spray-painting, coating and printing techniques; (4) adhering a substrate-based thin film to the adhesive layer; and (5) removing the substrate-based thin film to remove the part of the metal layer outside the blank area and the release layer together with the adhesive layer and the substrate-based thin film from the thin film substrate and to leave a metallic pattern layer on the surface of the thin film substrate. Alternatively, a substrate-based thin film carrying an adhesive layer can be adhered to the surface of the metal layer to substitute the aforesaid step (3) and step (4).

Because the release layer that covers on the thin film substrate has a blank area of a predetermined pattern (such as lines, letters, symbols, numerals, and so on) in it, the metal layer is tightly joined to the blank area and the thin film substrate after the metal layer is applied. Therefore, when the substrate-based thin film is removed, the metal layer outside the blank area and the release layer will be removed together with the adhesive layer and the substrate-based thin film from the thin film substrate, leaving a metallic pattern layer on the surface of the thin film substrate. Because the invention does not need to wash the metal layer with an acidic solvent, alkaline solvent or any other chemical solvent or reagent, no further waste water treatment procedure is necessary. Therefore, the thin film fabrication method of the present invention is environmentally friendly and can effectively reduce the manufacturing cost.

### BRIEF DESCRIPTION OF THE DRAWINGS

FIG. 1 is a flowchart of a method for making a thin film having a metallic pattern layer in accordance with the present invention.

FIG. 2 is a flowchart of an alternate form of the method for making a thin film having a metallic pattern layer in accordance with the present invention.

FIG. 3 is a schematic top view of a release layer prepared according to the present invention.

FIG. 4 is a schematic sectional view of the release layer on the thin film substrate according to the present invention.

FIG. 5 is a schematic top view of a metal layer on the release layer according to the present invention.

FIG. 6 is a schematic sectional view of the metal layer on the release layer on the thin film substrate according to the present invention.

FIG. 7 is a schematic top view of an adhesive layer on the metal layer according to the present invention.

FIG. 8 is a schematic sectional view of the adhesive layer on the metal layer on top of the release layer above the thin film substrate according to the present invention.

FIG. 9 is a schematic top view of a substrate-based thin film adhered to the adhesive layer according to the present invention.

FIG. 10 is a schematic sectional view of the substrate-based thin film adhered to the adhesive layer on top of the metal layer above the release layer and the thin film substrate.

FIG. 11 illustrates the removal of the substrate-based thin film according to the present invention.

FIG. 12 corresponds to FIG. 11, showing the release layer, a part of the metal layer and the adhesive layer separated with the substrate-based thin film from the thin film substrate.

FIG. 13 is a schematic top view of a finished thin film having a metallic pattern layer according to the present invention.

### DETAILED DESCRIPTION OF THE PREFERRED EMBODIMENTS

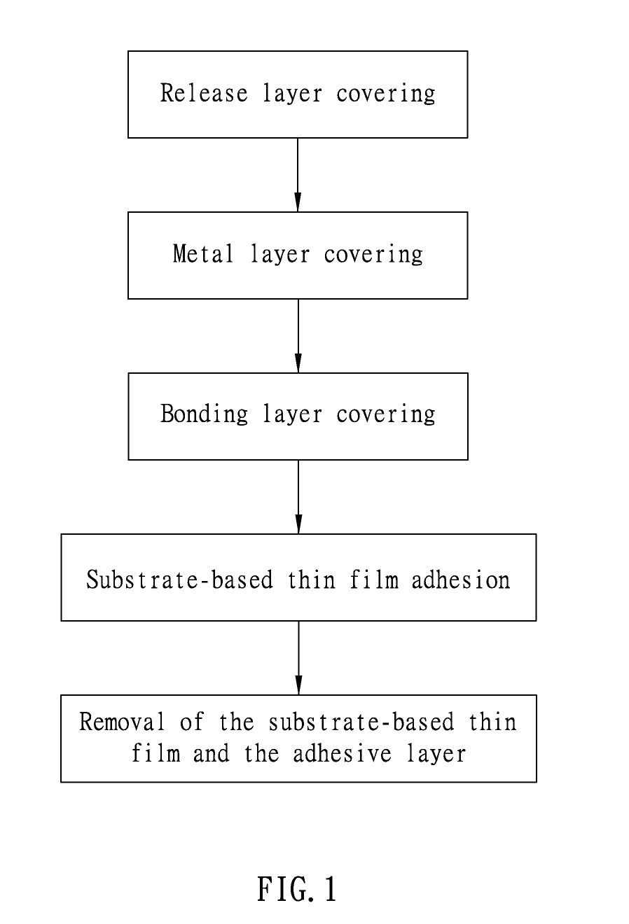

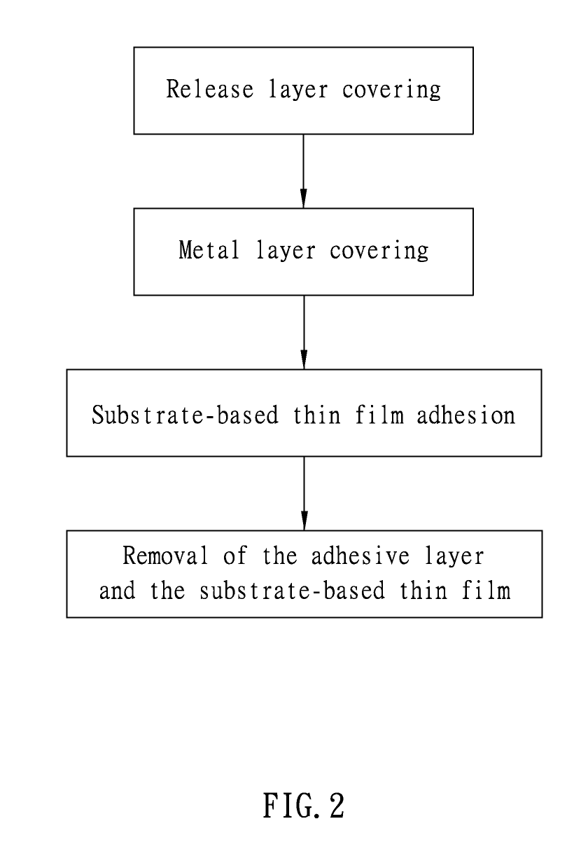

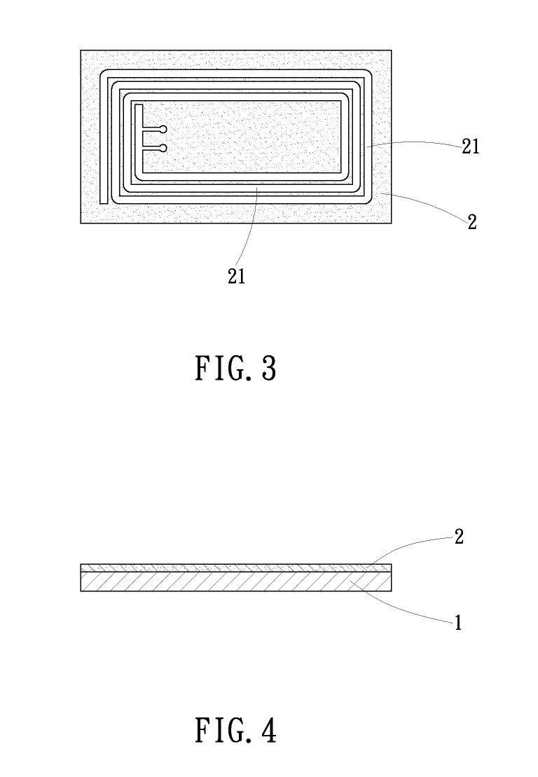

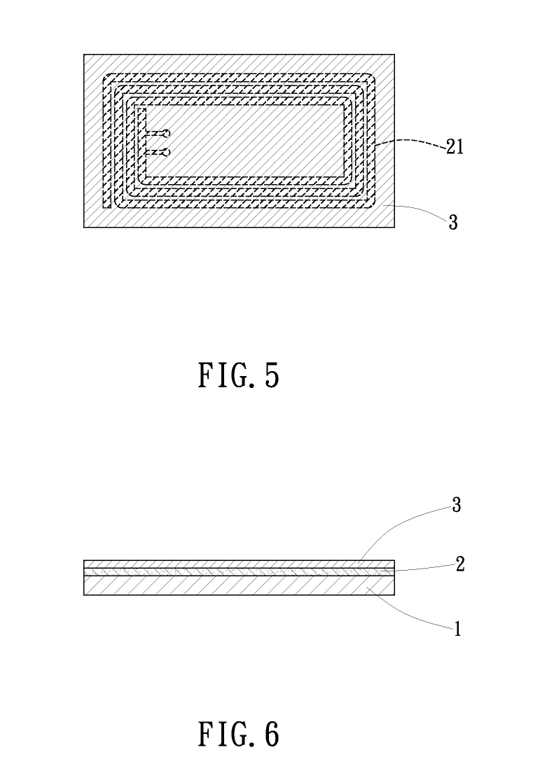

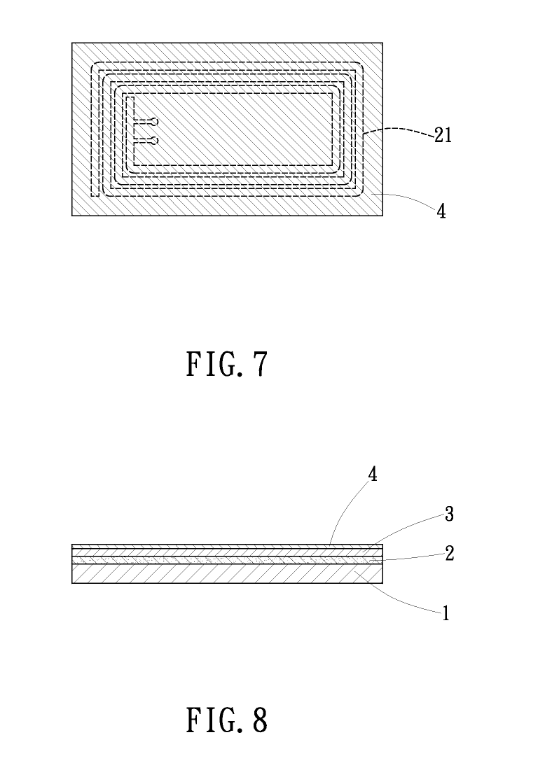

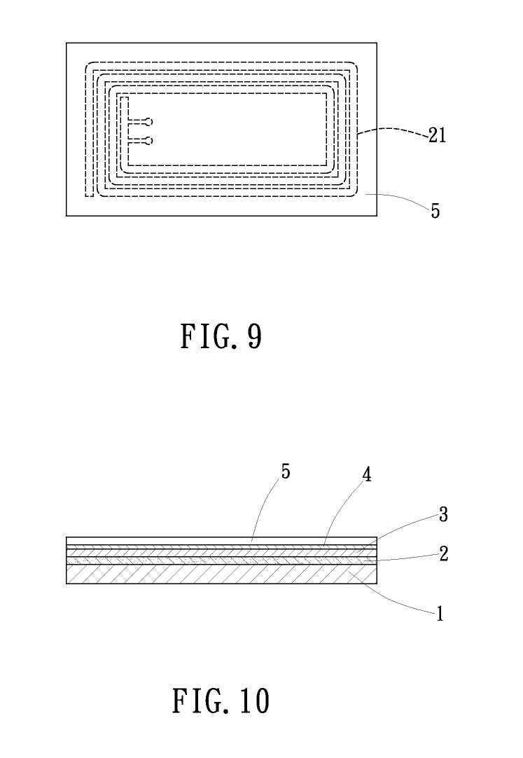

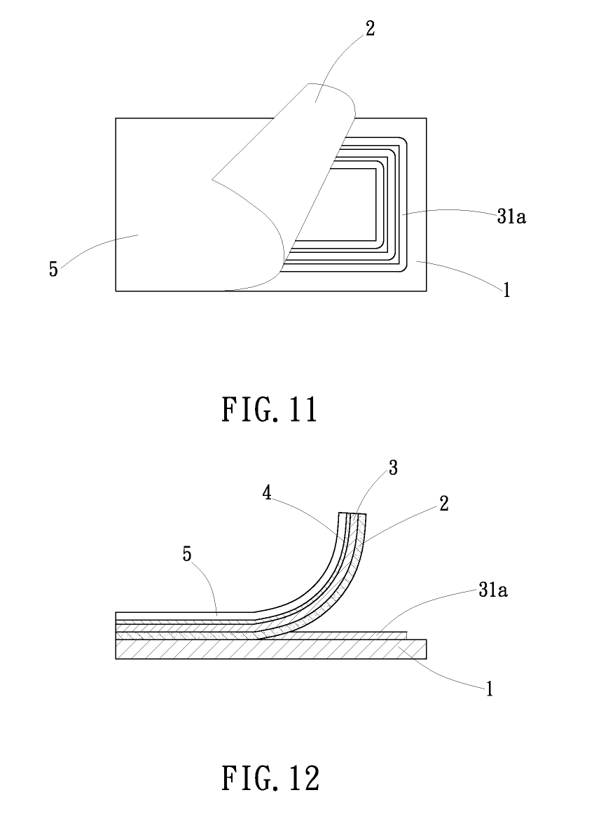

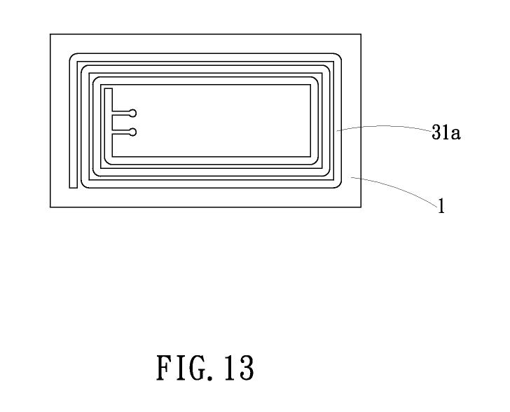

Referring to FIGS. 1 and 2, a method for making a thin film having a metallic pattern layer in accordance with the present invention includes the following steps:
(1) Release layer covering: As shown in FIGS. 3 and 4, cover the surface of a thin film substrate 1 with a release layer 2 by means of spray-painting, coating or printing technique, leaving a blank area 21 of a predetermined pattern (such as lines, letters, symbols, numerals, and so on) in the release layer 2. The thin film substrate 1 can be a paper film, a plastic film or an induction plastic film made from a high molecular chemical reaction engineering material of thermosetting resin and/or thermoplastic resin, such as PU (polyurethane), UP (unsaturated polyester), PS (polystyrene) and other high molecular polymers. The release layer 2 is a transparent or a colored layer prepared from a hydrophilic or lipophilic resin material such as polyvinyl alcohol or polyvinyl acetate, etc.
(2) Metal layer covering: As shown in FIGS. 5 and 6, cover the whole surface of the release layer 2 and the blank area 21 with a metal layer 3 by means of electroplating, spattering, or vacuum deposition technique.
(3) Adhesive layer covering: As shown in FIGS. 7 and 8, cover the surface of the metal layer 3 with an adhesive layer 4 by means of spray-painting, coating or printing technique.
(4) Substrate-based thin film adhesion: As shown in FIGS. 9 and 10, adhere a substrate-based thin film 5 on the adhesive layer 4. The substrate-based thin film 5 can be prepared from paper, high molecular polymers or organic compounds.
(5) Removal of the substrate-based thin film and the adhesive layer: As shown in FIGS. 11 and 12, remove the substrate-based thin film 5. At this time, the part of the metal layer 3 outside the blank area 21 and the release layer 2 are removed together with the adhesive layer 4 and the substrate-based thin film 5 from the thin film substrate 1, leaving a metallic pattern layer 31a on the surface of the thin film substrate 1 for RFID (radio frequency identification) system, antennas of wireless transmission systems, flexible printed circuit boards or chip on film (chip on flex) applications.

In an alternate form as shown in FIGS. 9 and 10, a substrate-based thin film 5 carrying an adhesive layer 4 is adhered to the surface of the metal layer 3 to substitute the aforesaid step (3) and step (4).

As stated above, the release layer 2 that is on the thin film substrate 1 has a blank area 21 of a predetermined pattern (such as lines, letters, symbols, numerals, and so on) in it. After the metal layer 3 is covered on the whole surface of the release layer 2 and the blank area 21, the metal layer 3 is tightly joined to the blank area 21 and the thin film substrate 1. Therefore, when the substrate-based thin film 5 is remvoed, the metal layer 3 outside the blank area 21 and the release layer 2 will be removed together with the adhesive layer 4 and the substrate-based thin film 5 from the thin film substrate 1, leaving a metallic pattern layer 31a on the surface of the thin film substrate 1. Because the invention does not need to etch and wash the metal layer 3 with an acidic solvent, alkaline solvent or any other chemical solvent or reagent, no further waste water treatment procedure is necessary. Therefore, the thin film fabrication method of the present invention is environmentally friendly and can reduce the manufacturing cost effectively.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A method for making a thin film having a metallic pattern layer, comprising the steps of:
(1) preparing a thin film substrate and covering a release layer on one side of said thin film substrate by means of one of the techniques of spray-painting, coating and printing, leaving a blank area of a predetermined pattern in said release layer;
(2) covering a metal layer on the whole surface of said release layer and said blank area;
(3) covering the metal layer with an adhesive layer by means of one of spray-painting, coating and printing techniques;
(4) adhering a substrate-based thin film to said adhesive layer; and
(5) removing said substrate-based thin film to remove the part of said metal layer outside said blank area and said release layer together with said adhesive layer and said substrate-based thin film from said thin film substrate so that a metallic pattern layer is left on said thin film substrate.

2. The method as claimed in claim 1, wherein said thin film substrate is made from a thermosetting resin.

3. The method as claimed in claim 1, wherein said thin film substrate is made from a thermoplastic resin.

4. The method as claimed in claim 1, wherein said thin film substrate is a paper film.

5. The method as claimed in claim 1, wherein said thin film substrate is a plastic film.

6. The method as claimed in claim 1, wherein said thin film substrate is an induction plastic film.

7. The method as claimed in claim 3, wherein said substrate-based thin film is a paper film.

8. The method as claimed in claim 3, wherein said substrate-based thin film is a plastic film.

9. The method as claimed in claim 3, wherein said substrate-based thin film is an induction plastic film.

10. The method as claimed in claim 1, wherein said release layer is a transparent layer made of a hydrophilic resin.

11. The method as claimed in claim 1, wherein said release layer is a colored layer made of a hydrophilic resin.

12. The method as claimed in claim 1, wherein said release layer is a transparent layer made of a lipophilic resin.

13. The method as claimed in claim 1, wherein said release layer is a colored layer made of a lipophilic resin.

14. The method as claimed in claim 1, wherein said step (2) is performed by means of one of electroplating, sputter deposition and vacuum deposition techniques.

15. A method for making a thin film having a metallic pattern layer, comprising the steps of:
(1) preparing a thin film substrate and covering a release layer on one side of said thin film substrate by means of one of the techniques of spray-painting, coating and printing, leaving a blank area of a predetermined pattern in said release layer;
(2) covering a metal layer on the whole surface of said release layer and said blank area;
(3) covering the metal layer with a substrate-based thin film carrying an adhesive layer to adhere said adhesive layer to the metal layer; and
(4) removing said substrate-based thin film to remove the part of said metal layer outside said blank area and said release layer together with said adhesive layer and said substrate-based thin film from said thin film substrate, so that a metallic pattern layer is left on said thin film substrate.

16. The method as claimed in claim 15, wherein said thin film substrate is made from a thermosetting resin.

17. The method as claimed in claim 15, wherein said thin film substrate is made from a thermoplastic resin.

18. The method as claimed in claim 15, wherein said thin film substrate is a paper film.

19. The method as claimed in claim 15, wherein said thin film substrate is a plastic film.

20. The method as claimed in claim 15, wherein said thin film substrate is an induction plastic film.

21. The method as claimed in claim 15, wherein said substrate-based thin film is a paper film.

22. The method as claimed in claim 15, wherein said substrate-based thin film is a plastic film.

23. The method as claimed in claim 15, wherein said substrate-based thin film is an induction plastic film.

24. The method as claimed in claim 15, wherein said release layer is a transparent layer made of a hydrophilic resin.

25. The method as claimed in claim 15, wherein said release layer is a colored layer made of a hydrophilic resin.

26. The method as claimed in claim 15, wherein said release layer is a transparent layer made of a lipophilic resin.

27. The method as claimed in claim 15, wherein said release layer is a colored layer made of a lipophilic resin.

28. The method as claimed in claim 15, wherein said step (2) is performed by means of one of electroplating, sputter deposition and vacuum deposition techniques
